(19) United States
(12) Patent Application Publication
(10) Pub. No.: US 2019/0156846 A1
(43) Pub. Date: May 23, 2019

(54) CREATING DEVICE, CREATING METHOD, AND NON-TRANSITORY COMPUTER READABLE STORAGE MEDIUM

(71) Applicant: YAHOO JAPAN CORPORATION, Tokyo (JP)

(72) Inventors: Yusuke KIDA, Tokyo (JP); Tran DUNG, Tokyo (JP)

(73) Assignee: YAHOO JAPAN CORPORATION, Tokyo (JP)

(21) Appl. No.: 16/131,561

(22) Filed: Sep. 14, 2018

(30) Foreign Application Priority Data
Nov. 21, 2017 (JP) 2017-223704

(51) Int. Cl. G10L 21/02; G10L 15/08; G10L 15/22; G06N 99/00

(52) U.S. Cl. CPC G10L 21/0205; G10L 15/08; G10L 2015/088; G06N 99/005; G10L 15/22

(57) ABSTRACT

According to one aspect of an embodiment a creating device includes an estimating unit that estimates a predetermined range that is included in an observation signal and in which a predetermined signal is included. The creating device includes a creating unit that creates, based on an enhancement range in which the predetermined signal included in a signal included in the predetermined range has been enhanced, a filter that is used to enhance a signal having the same characteristic as that of the predetermined signal from a range other than the predetermined range that is included in the observation signal.

### CROSS-REFERENCE TO RELATED APPLICATIONS

The present application claims priority to and incorporates by reference the entire contents of Japanese Patent Application No. 2017-223704 filed in Japan on Nov. 21, 2017.

### BACKGROUND OF THE INVENTION

### 1. Field of the Invention

The present invention relates to a creating device, a creating method, and a non-transitory computer readable storage medium.

### 2. Description of the Related Art

Conventionally, there is a known technology for improving the accuracy of recognition of a signal targeted for recognition (hereinafter, sometimes referred to as a “target signal”) from among a plurality of signals included in an observation signal. As an example of such a technology, there is a proposed beamforming process that estimates, based on the result of comparing measurement signals that are measured by a plurality of measurement devices at the same time, the direction corresponding to the transfer source of the target signal and that enhances the signal transferred from the estimated direction.

Patent Literature 1: Japanese Laid-open Patent Publication No. 2017-90853

However, with the conventional technology, there is a possibility of not improving the accuracy of recognition of the target signal.

For example, the conventional technology described above is used to estimate a time zone in which the target signal included in the observation signal is included and calculate, by using the observation signal in the estimated time zone, a spatial correlation matrix that is used to enhance the target signal. However, with this technology, if a signal (for example, a signal corresponding to noise, a reverberation signal, etc.) other than the target signal is included in the estimated time zone, there may be a possibility of calculating a spatial correlation matrix that enhances the signal other than the target signal.

### SUMMARY OF THE INVENTION

It is an object of the present invention to at least partially solve the problems in the conventional technology.

According to one aspect of an embodiment a creating device includes an estimating unit that estimates a predetermined range that is included in an observation signal and in which a predetermined signal is included. The creating device includes a creating unit that creates, based on an enhancement range in which the predetermined signal included in a signal included in the predetermined range has been enhanced, a filter that is used to enhance a signal having the same characteristic as that of the predetermined signal from a range other than the predetermined range that is included in the observation signal. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a learning process and a creating process performed by an information providing device according to an embodiment;

FIG. 2 is a diagram illustrating a configuration example of the information providing device and a voice device according to the embodiment;

FIG. 3 is a diagram illustrating an example of information registered in a learning database according to the embodiment;

FIG. 4 is a diagram illustrating an example of information registered in an observation signal database according to the embodiment;

FIG. 5 is a diagram illustrating an example of results of processes in each of which the information providing device according to the embodiment enhances a signal;

FIG. 6 is a flowchart illustrating an example of the flow of the process performed by the information providing device according to the embodiment; and

FIG. 7 is a diagram illustrating an example of hardware configuration.

### DETAILED DESCRIPTION OF THE PREFERRED EMBODIMENTS

A mode (hereinafter, referred to as an “embodiment”) for carrying out a creating device, a creating method, and a non-transitory computer readable storage medium according to the present application will be described in detail below with reference to the accompanying drawings. The creating device, the creating method, and the non-transitory computer readable storage medium according to the present application are not limited to the embodiment. Furthermore, each of the embodiments can be appropriately used in combination as long as the content of processes does not conflict with each other. Furthermore, in the embodiments below, the same components are denoted by the same reference numerals and overlapping descriptions will be omitted.

### 1. Outline of an Information Providing Device

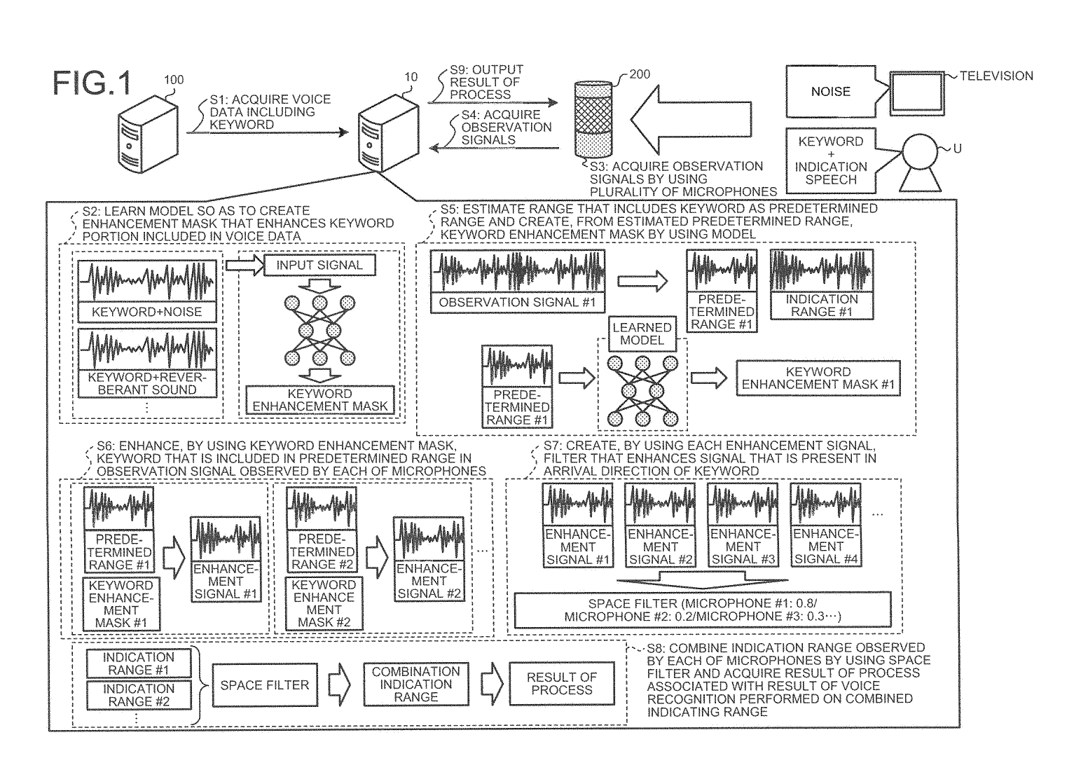

First, an example of a learning process and a creating process performed by an information providing device that is an example of a creating device will be described with reference to FIG. 1. FIG. 1 is a diagram illustrating an example of the learning process and the creating process performed by the information providing device according to an embodiment. In FIG. 1, an information providing device 10 is an information processing apparatus that performs the learning process and the creating process described below and is implemented by, for example, a server device, a cloud system, or the like.

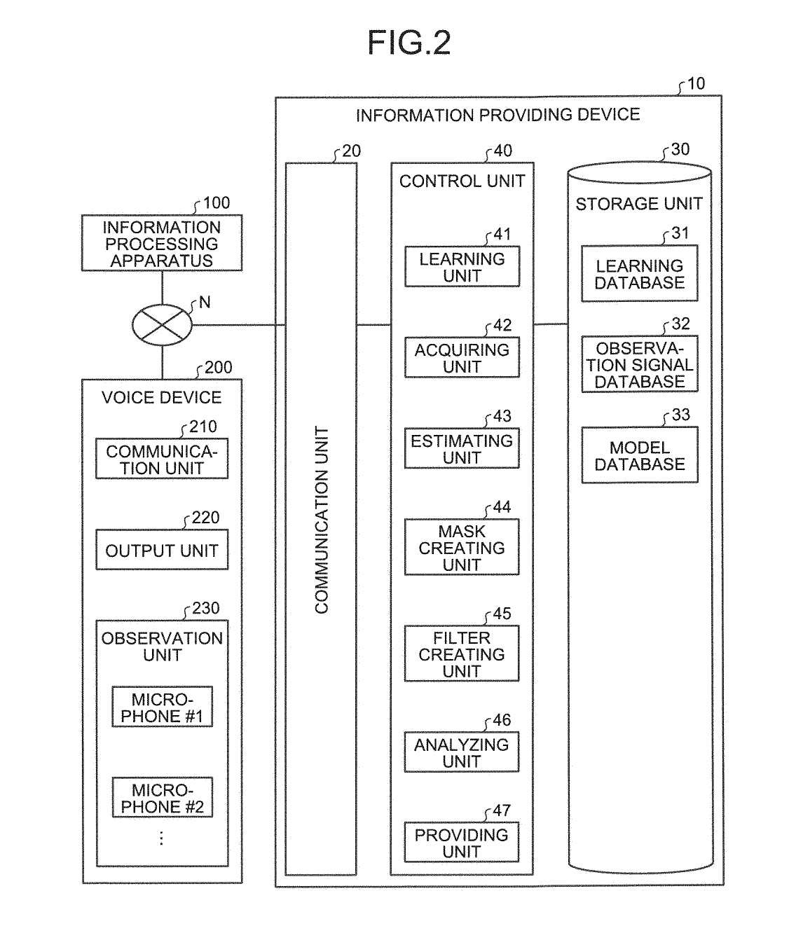

For example, the information providing device 10 can communicate with a predetermined information processing apparatus 100 and a voice device 200 via a predetermined network N, such as the Internet (for example, see FIG. 2). For example, the information providing device 10 sends and receives various kinds of data, such as data related to voices, to and from the information processing apparatus 100 and the voice device 200.

The information processing apparatus 100 is an information processing apparatus that holds various kinds of data and is implemented by a server device, a cloud system, or the like. For example, the information processing apparatus 100 holds learning data that is used in the learning process, which will be described later, and provides the learning data to the information providing device 10.

The voice device 200 is an input-output device that includes both an acquisition device, such as a microphone, that acquires ambient sounds and an output device, such as a speaker, that can output an arbitrary sound and is, for example, a device called a smart speaker. For example, the voice device 200 is a device that can implement outputting music or providing information by voices by using the output device. Furthermore, the voice device 200 has a reception function of receiving an input of sounds and has an output function of outputting, when acquiring the voice output by a user U, a sound in accordance with the content of the acquired voice.

For example, if the user U outputs voice indicating a name of a predetermined piece of music, the voice device 200 specifies, by using various kinds of voice analysis technologies, the name of the piece of music indicated by the voice and acquires data of the music indicated by the specified name of the piece of music from a predetermined external server (not illustrated) via a network N (for example, see FIG. 2). Then, the voice device plays back the acquired music.

Furthermore, the voice device 200 has a function of specifying, for example, the content of the voice output by the user U by using various kinds of voice analysis technologies and outputting a response in accordance with the specified content. For example, if the voice device 200 acquires the voice, such as “what is the weather today?”, output by the user U, the voice device 200 acquires various kinds of weather information, such as the weather of the air temperature, from an external server and provides information on the weather to the user U by reading out the acquired weather information. Furthermore, in addition to the process described above, the voice device 200 is a smart speaker that can implement various processes of, for example, placing an order for a product exhibited in an electronic mall, controlling various household electrical appliances, such as air conditioning devices or lighting devices, reading out mails or schedules, and the like.

Here, it is assumed that the voice device 200 includes a plurality of acquisition devices (for example, microphones, etc.) attached to different positions and performs various processes described above by using the voice received via each of the acquisition devices. Furthermore, the voice device 200 may also be an arbitrary device, such as a smart device or a recording device, as long as the device has a plurality of acquisition devices that are placed at different positions. Furthermore, the voice device 200 may also be a device that is connected to a plurality of acquisition devices placed at physically separated positions via wireless communication, such as a wireless local area network (LAN) or Bluetooth (registered trademark), and that collects the voices acquired by each of the acquisition devices.

Furthermore, in the description below, it is assumed that the voice device 200 includes a plurality of microphones as input devices. Furthermore, in the description below, the voice signal acquired by each of the microphones is sometimes referred to as an observation signal.

### 1-1. Process Performed by the Information Providing Device 10

Here, in order to accurately analyze the voice output by the user U, there is a known technology called beamforming. With this technology, spatial information between the direction of the voice output by the user U and a microphone is estimated. Then, in order to enhance the voice arriving from the direction of the voice output by the user U, assigning weights to the observation signal observed by each of the microphones by using the estimated spatial information and each of the observation signals is combined.

Here, in order to improve the accuracy of recognition of the voice signal, i.e., the target signal, such as “play the music” or “what is the weather today?”, of the voice of the user U who corresponds to the recognition target, it is conceivable to use a method of using the beamforming technology described above. However, if, in the observation signal, not only the target signal but also the signal including, for example, noise or a reverberant sound (hereinafter, collectively referred to as a “noise signal”) are included, the noise signal may possibly be enhanced. For example, if voice is output from a television or a radio, even if the user U speaks “what is the weather today?”, there may be a possibility that the voice signal of the voice that is output from the television or the radio is erroneously recognized as the target signal, the voice signal of the voice that is output from the television or the radio is enhanced, and the voice signal of a speech output from the user U is reduced as a noise signal.

In contrast, if some sort of indication is given to the voice device 200 by using voice, it is conceivable to use a method of speaking a predetermined keyword and then continuously speaking the content of the indication. Thus, the information providing device 10 performs the creating process described below.

First, the information providing device 10 estimates a predetermined range that if included in the observation signal and in which a predetermined signal is included. Then, based on an predetermined range in which the predetermined signal included in a signal that is included in the predetermined range has been enhanced (hereinafter, referred to as an “enhancement range”), the information providing device 10 creates a filter that is used to enhance a signal having the same characteristic as that of the predetermined signal from the range other than the predetermined range that is included in the observation signal. For example, the information providing device 10 estimates, as a predetermined range, the range in which the predetermined signal included in a voice signal is included. Then, the information providing device 10 creates an enhancement range in which the signal that is estimated as the predetermined signal that is included in the signal included in the predetermined range and creates, based on each of the signals included in the created enhancement range (hereinafter, referred to as an “enhancement signal”), a filter that is used to enhance the signal having the same characteristic as that of the predetermined signal included in the voice signal from the range other than the predetermined range.

For example, the information providing device 10 acquires the observation signal observed by each of the microphones included in the voice device 200. In such a case, the information providing device 10 estimates, for each observation signal, as the predetermined range, the range in which, as the predetermined signal, a signal having a predetermined characteristic of the waveform or the frequency characteristic is included. More specifically, the information providing device 10 estimates, regarding the voice signal observed as the observation signal, the range in which the voice signal obtained when the user U spoke a predetermined keyword is included as the predetermined range. Furthermore, the information providing device 10 may also estimate the predetermined range from the observation signal observed by a single microphone and share the estimated predetermined range by each of the microphones. For example, if the information providing device 10 estimates a certain range in the observation signal observed by a first microphone as the predetermined range, the information providing device 10 may also set, when the first microphone observed the predetermined range, the range in the observation signal that was being observed by a second microphone to the predetermined range that includes the observation signal observed by the second microphone.

Then, the information providing device 10 creates a filter that is used to enhance the signal having the same characteristic as that of the predetermined signal from the range subsequent to the predetermined range that is included in the observation signal. Namely, in the observation signal, the information providing device 10 creates a filter that is used to enhance the voice signal observed after the voice signal at the time at which the user U spoke a keyword (hereinafter, referred to as a “keyword signal”), i.e., the voice signal having the content of the indication that was spoken after the keyword.

Here, in the estimated predetermined range, in addition to the keyword signal, a noise signal or a signal containing a reverberant sound may possibly be included. Thus, the information providing device 10 creates, in each of the signals included in the predetermined range, an enhancement range in which the signal that is estimated to be a keyword signal (for example, a signal having a frequency characteristic or the like similar to the keyword signal) has been enhanced. More specifically, by using a model obtained by learning the characteristic held by the predetermined signal, such as the keyword signal, the information providing device 10 estimates a signal having the characteristic similar to that of the keyword signal that is included in each of the signals included in the predetermined range and then creates a mask that enhances the estimated signal. Then, the information providing device 10 creates, by using the mask, the enhancement range in which the predetermined signal included in each of the signals included in the predetermined ranges has been enhanced and creates, by using the signal included in the enhancement range, i.e., by using the enhancement signal, the filter that enhances the signal similar to that of the keyword signal from the observation signal.

In other words, instead of simply using the predetermined range that is included in the observation signal and in which the keyword signal is included without processing anything, by using the enhancement signal that is obtained by enhancing the predetermined signal that is included in the signal included in the predetermined range, the information providing device 10 creates a filter that is used to enhance the target signal that is subsequent to the keyword signal. Then, the information providing device 10 enhances, by using the created filter, the target signal from the observation signal and analyzes the target signal. For example, the information providing device 10 specifies the content of the indication speech of the user U from the target signal by using the voice analysis technology and performs the process in accordance with the specified content. In this way, based on the enhancement signal in which the predetermined signal has been enhanced, the information providing device 10 creates the filter that is used to enhance the signal having the characteristic that is common to the predetermined signal, thereby improving the accuracy of the filter.

### 1-2. Filter Created by the Information Providing Device 10

Here, the information providing device 10 may create an arbitrary filter as long as the filter is used to enhance the target signal from the observation signal. For example, because a keyword and an indication speech are spoken by the same user U, the arrival direction of the voice and the frequency characteristic are conceivably similar. Thus, the information providing device 10 creates a filter that is used to enhance, as the target signal, the signal having a spatial characteristic of a frequency characteristic similar to that of the keyword signal from among the various signals included in the observation signal.

For example, the information providing device 10 estimates, as a spatial characteristic, the arrival direction of the keyword signal and creates a filter that is used to enhance the signal arriving from the estimated direction as the target signal. More specifically, the information providing device 10 creates, for each microphone, a weighting factor used when combining a plurality of observation signals simultaneously acquired by the plurality of microphones that are placed at different locations. Namely, the information providing device 10 creates a filter that is used to enhance signals each having a spatial characteristic (for example, the arrival direction of the signal) similar to that of the predetermined signal from the range other than the predetermined range that is included in each of the plurality of the observation signals.

For example, the information providing device 10 creates a filter that is used to enhance the target signal by using a known microphone array technology. For example, the information providing device 10 enhances the target signal by correcting a temporal shift of the observation signal observed by each of the microphones and summing the corrected observation signals. Alternatively, the information providing device 10 enhances the target signal by performing frequency conversion on the observation signal and performing filtering in the frequency domain. For example, the information providing device 10 performs multiplication of Y(f)=W(f)×X(f), where the signal with the frequency f subjected to Fourier transformation is represented by X(f) and the filter (weight) is represented by W(f) and again returns Y(f) to a time signal by performing inverse Fourier transformation on Y(f) that is obtained for each frequency f, thereby obtaining the observation signal in which the target signal has been enhanced.

Furthermore, in addition to the spatial characteristic, the information providing device 10 may also create a filter that is used to enhance the signal having the frequency characteristic similar to that of, for example, a predetermined signal. For example, the information providing device 10 estimates the predetermined range from the observation signal and extracts, as the keyword signal, the signal having a predetermined characteristic (for example, a signal having a predetermined characteristic of waveform) from the signal included in the estimated predetermined range. Then, the information providing device 10 may also specify the frequency characteristic held by the extracted keyword signal and create a filter that is used to enhance the signal that has the specified frequency characteristic and that is included in the signal included in the range that is other than the predetermined range in the observation signal.

### 1-3. Estimating a Predetermined Range and Extracting a Predetermined Signal

Here, the information providing device 10 may also estimate the predetermined range by using an arbitrary method. For example, by using a known technology for estimating a voice, the information providing device 10 may also estimate the range that is in the observation signal and in which the keyword signal is included. More specifically, the information providing device 10 may also previously learn the characteristic of the waveform or the frequency characteristic of the keyword signal and estimate the range in which the signal having the learned characteristic is highly likely to be included in the observation signal as the range in which the keyword signal is included, i.e., as the predetermined range.

Here, if the keyword signal is not able to be appropriately extracted from the predetermined range, the accuracy of the filter that enhances the target signal may possibly be degraded. Thus, by using the model obtained by learning the characteristic held by the predetermined signal, such as the keyword signal, the information providing device 10 may also enhance the similar signal having the characteristic similar to that of the predetermined signal that is included in the signals included in the predetermined range and create a filter based on the predetermined range in which the similar signal has been enhanced. Namely, by enhancing the similar signal included in the signals included in the predetermined range, the information providing device 10 creates an enhancement signal in which the signal that is estimated to be a noise signal or a reverberant sound signal has been reduced. Then, the information providing device 10 may also create a filter by using the enhancement signal. As the result, because the information providing device 10 creates a filter by using the signal that significantly contributes to the signal that is estimated to be the keyword signal, thereby implementing creation of the filter that more accurately enhances an indication speech of a user.

For example, the information providing device 10 previously performs a learning process of learning a model obtained by performing deep learning on the waveform or the frequency characteristic in the range that is included in the observation signal and in which the predetermined signal is included. Then, by using the learned model, the information providing device 10 enhances the keyword signal included in the learned predetermined range and creates, by using the enhancement signal including the enhanced keyword signal, a filter that is used to enhance the target signal.

In the following, an example of the learning process performed by the information providing device 10 will be described. For example, the information providing device 10 prepares a neural network in which a plurality of nodes is connected in multiple stages as a model. This type of model may also be, for example, a Deep Neural Network (DNN), a Long Short-Term Memory (LSTM) convolution neural network, or a recursive neural network. Furthermore, the model may also be a combination of functions of these convolution neural networks or recursive neural networks. Furthermore, the information providing device 10 may also use an arbitrary regression model, such as support vector regression.

Subsequently, the information providing device 10 acquires a signal used for the learning process (hereinafter, sometimes referred to as a “learning signal”). For example, the information providing device 10 acquires voice signals having various keywords spoken in an environment with little noise and acquires various noise signals including noise, echoing sounds, or the like. Then, the information providing device 10 acquires a mixed signal of the acquired voice signals and the noise signals as the learning signals and performs learning of a model so as to output a mask (hereinafter, referred to as a “keyword enhancement mask”) that is used to enhance the keyword signal included in the learning signal by using the acquired learning signal, i.e., the mixed signal, as an input signal to the model and by using the mask that indicates the ratio of the keyword voice signals included in the mixed signal as a teacher signal.

For example, when the learning signal is input as an input signal, for each combination obtained by dividing the input signal into a combination of a frequency band in a predetermined range and a time zone having a predetermined length, the information providing device 10 learns the model so as to calculate the likelihood that the signal constituting the keyword signal is included. More specifically, the information providing device 10 divides the learning signal into a combination of the frequency band and the time zone and determines whether the keyword signal is included in each of the combinations. Then, in the case where the learning signal is input to the model, the information providing device 10 learns the model such that the likelihood of the combination in which the keyword signal is included is high and the likelihood of the combination in which the keyword signal is not included is low. For example, the information providing device 10 allows the model to learn the characteristic held by the keyword signal by correcting the connection coefficient between the nodes included in the model, i.e., the weighting factor used when a certain node transfers a value to the subsequent node.

Furthermore, the information providing device 10 inputs, to the learned model as an input signal, the estimated predetermined range included in the observation signal. In such a case, the learned model outputs, for each combination of the frequency band and the time zone of the input signal, the likelihood that the keyword signal is included. Namely, from among each of the signals included in the input signal, the learned model outputs, for each combination of the frequency band and the time zone of the input signal, the likelihood that the signal that is highly likely to have the characteristic similar to that of the keyword signal is included. This type of likelihood can be used as a mask that enhances the predetermined signal, such as the keyword signal, and reduce the other signals, such as noise that is included in the signal included in the predetermined range. Consequently, the information providing device 10 enhances, by using the likelihood output by the learned model, the keyword signal included in the predetermined range. For example, from among the combinations of the frequency band and the time zone included in the predetermined range, the information providing device 10 may also increase the amplitude of the signal included in the combination in which the likelihood output by the learned model exceeds a predetermined threshold and may also decrease the amplitude of the signal included in the other combinations. Furthermore, regarding the amplitude of the signal included in each of the combinations, the information providing device 10 may also add up the likelihood output by the learned model or add up the coefficients that are in accordance with the likelihood. Namely, the information providing device 10 uses the likelihood output by the learned model as a keyword enhancement mask.

As the results of the processes described above, the information providing device 10 can obtain the predetermined range in which the keyword signal has been enhanced, i.e., the enhancement range. By performing the process described above on each of the predetermined ranges estimated from the corresponding observation signals, the information providing device 10 can appropriately extract the characteristic held by the keyword signal and create the filter that enhances the target signal.

### 1-4. Example of the Process Performed by the Information Providing Device 10

In the following, an example of the flow of the process performed by the information providing device 10 will be described with reference to FIG. 1. For example, the information providing device 10 acquires voice data including a keyword as a learning signal from the information processing apparatus 100 (Step S1). In such a case, the information providing device 10 learns a model so as to create a keyword enhancement mask that enhances a voice portion in the keyword included in the voice data (Step S2). For example, if a signal in which the voice of the keyword and noise are mixed or a signal in which the voice of the keyword and a reverberant sound are mixed is input as an input signal, the information providing device 10 learns the model so as to output the keyword enhancement mask that enhances the voice portion of the keyword, i.e., the portion of the keyword signal.

In contrast, the voice device 200 acquires observation signals by using a plurality of microphones (Step S3). For example, the voice device 200 acquires, in addition to a speech output by the user U, the voice signal that includes noise, such as the voice output from a television, as an observation signal. Furthermore, in the example illustrated in FIG. 1, it is assumed that, in the speech output by the user U, a keyword and an indication speech are included.

In such a case, the information providing device 10 acquires the observation signal acquired by each of the microphones (Step S4). Then, the information providing device 10 estimates, for each observation signal, the range that includes the keyword as a predetermined range and creates, from the estimated predetermined range, the keyword enhancement mask by using the model (Step S5).

For example, the information providing device 10 analyzes an observation signal #1 acquired by a microphone #1 and extracts the range in which the keyword signal is highly likely to be included as a predetermined range #1. Furthermore, the information providing device 10 extracts, regarding the observation signal #1, the range that is subsequent to the predetermined range #1 (for example, a range of several tens of seconds or a range in which voice is included) as an indication range #1 in which the indication speech is included.

Subsequently, the information providing device 10 inputs the predetermined range #1 to the learned model as the input signal and acquires, from the predetermined range #1, a keyword enhancement mask #1 that is used to enhance the keyword signal. Then, the information providing device 10 enhances, by using the keyword enhancement mask, the keyword that is included in the predetermined range in the observation signal observed by each of the microphones (Step S6). For example, the information providing device 10 uses the predetermined range #1 and the keyword enhancement mask #1 and creates an enhancement signal #1 in which the keyword signal has been enhanced in the signal included in the predetermined range #1. Furthermore, the information providing device 10 estimates a predetermined range #2 from an observation signal #2 acquired by a microphone #2 and creates, from a keyword enhancement mask #2 created from the estimated predetermined range #2 and from the predetermined range #2, an enhancement signal #2 in which the keyword signal has been enhanced in the signal that is included in a predetermined range #2. Furthermore, the information providing device 10 also performs the same process on the observation signals acquired by the other microphones and acquires the enhancement signals in each of which the keyword signal has been enhanced for each microphone.

Then, the information providing device 10 creates, by using each of the enhancement signals, the filter that enhances the signal that is present in the arrival direction of the keyword (Step S7). For example, by comparing the enhancement signals #1 to #4 created from the observation signals #1 to #4 that are acquired by the microphone #1 to a microphone #4, respectively, the information providing device 10 specifies the variation in the timing of acquisition time of the keyword signal or the variation in the intensity of the keyword signal and then estimates the arrival direction of the keyword signal based on the relationship between the variation in the timing and the placement position of each of the microphones. Then, the information providing device 10 creates the filter that is used to enhance the signal arriving from the estimated direction as a space filter. For example, the information providing device 10 sets, for each microphone, the weighting factor used when the observation signals acquired by the corresponding microphones are combined.

Furthermore, the information providing device 10 may also create a filter by using various beamforming technologies, such as Minimum Variance Distortionless Response (MVDR), Generalized Eigenvalue (GEV), or Maximum Likelihood (ML).

Then, the information providing device 10 combines the indication range observed by each of the microphones by using the space filter and acquires the result of the process associated with the result of voice recognition performed on the combined indication range (Step S8). For example, regarding the amplitude of the signal included in the indication range that has been acquired by each of the microphones, the information providing device 10 creates a signal obtained by adding up the coefficient that is set for each of the microphones and creates the combination indication range obtained by combining the created signals. Then, the information providing device 10 recognizes, by using the voice recognition technology, the indication range included in the combination indication range and acquires the result of the process that is in accordance with the recognition process. Then, the information providing device 10 outputs the result of the process to the voice device 200 (Step S9).

As described above, the information providing device 10 estimates, from the observation signal, the predetermined range in which the keyword signal is included and creates, based on the signal included in the estimated predetermined range, the filter that enhances the indication speech included in the range that is subsequent to the predetermined range. Then, because the information providing device 10 enhances the indication speech by using the crated filter and recognizes the enhanced indication speech, the information providing device 10 can accurately recognize the indication speech spoken by the user U and provide an appropriate result of the process.

### 1-5. Entity of Execution of Process

In the example described above, the information providing device 10 learns the learned model; estimates, from the observation signal, the predetermined range in which the keyword signal is included; creates the keyword enhancement mask from the predetermined range by using the model; enhances the keyword signal by using the keyword enhancement mask; creates the filter by using the enhancement signal in which the keyword signal has been enhanced; and specifies the indication speech by using the filter. However, the embodiment is not limited to this.

For example, each of the processes described above may also be performed by the voice device 200 as standalone. Furthermore, the information providing device 10 may also learn the learned model and provide the learned model to the voice device 200. Namely, the information providing device 10 may also be a learning device that learns the model.

For example, the voice device 200 may also estimate, from the observation signal, the predetermined range in which the keyword signal is included and create, from the predetermined range, the keyword enhancement mask by using the learned model. Furthermore, the voice device 200 may also enhance the keyword signal by using the keyword enhancement mask and create the filter by using the enhancement signal in which the keyword signal has been enhanced. Then, the voice device 200 may also specify the indication speech by using the filter and provide the specified indication speech to the information providing device 10. In such a case, the information providing device 10 may also perform the process in accordance with the indication speech acquired from the voice device 200 and provide the result of the process to the voice device 200.

Furthermore, each of the processes described above may also be implemented by one of the information providing device 10 and the voice device 200. Furthermore, the process of recognizing the indication speech from the combination indication range combined by using the filter may also be implemented by an arbitrary external server that performs voice recognition.

Furthermore, for example, the information providing device 10 may also be a device that creates, by using the learned model that was learned by the other learning device, the keyword enhancement mask from the estimation range and provide the created keyword enhancement mask to the other server device. Furthermore, the information providing device 10 may also be a creating device that enhances the keyword signal from the observation signal by using the keyword enhancement mask created by the other server device and create the filter that enhances the target signal by using the enhanced keyword signal.

### 1-6. Application Range of the Process

In the explanation described above, the information providing device 10 uses the voice signal acquired by the voice device 200 as the observation signal, estimates the predetermined range from the observation signal, and creates the filter that enhances the voice signal of the indication speech as the target signal. However, the embodiment is not limited to this. Namely, the creating process of creating the filter and the processes described above can be used for not only voice but also an arbitrary observation target having an arbitrary waveform.

For example, the information providing device 10 acquires, as the observation signal, a radio wave from a mobile terminal acquired by each of a plurality of antennas. In such a case, the information providing device 10 may also estimate, as the predetermined range, the range in which the predetermined signal, such as a radio wave at the time of performing a handshake is included; enhance the predetermined signal from the predetermined range; estimate the direction of the terminal device based on the positional relationship between the enhanced predetermined signal and each of the antennas; and create the filter that enhances the radio wave arriving from the estimated direction.

Furthermore, in addition to the keyword signal, the information providing device 10 may also use an arbitrary signal as the predetermined signal. For example, the information providing device 10 may also use, as a predetermined signal, a signal that is highly likely to be observed before a target signal is observed and create the filter that enhances the target signal from the predetermined range in which the predetermined signal is included.

### 1-7. Content of Learning the Model

In the example described above, the information providing device 10 learns the model so as to output the keyword enhancement mask that enhances the keyword signal. However, the embodiment is not limited to this. For example, at the time of input of certain input information, the model, such as the DNN, can perform the learning such that output information that is based on the characteristic held by the subject input information is output. By considering the characteristic of this model, for example, the information providing device 10 may also learn the model, at the time of input of the learning signal, so as to directly output the amplitude of the keyword signal included in each of the combinations of the time zone and the frequency band. For example, the information providing device 10 acquires, as a teacher signal, the keyword signal included in the mixed signal that corresponds to the input signal. Then, the information providing device 10 may also learn the model such that the keyword signal is output at the time of input of mixed signal to the model.

As described above, the information providing device 10 extracts, by using the model in which the characteristic of the predetermined signal, such as the keyword signal, has been learned, the predetermined signal from the signal included in the predetermined range. Namely, the information providing device 10 enhances by using the model, the predetermined signal from among the signals included in the predetermined range and creates the enhancement range in which the other signals, such as the noise signals, are reduced. Then, the information providing device 10 may also create the filter by using the predetermined signal estimated by the model from the signal included in the created enhancement range, i.e., included in the predetermined range. Namely, the process of enhancing the predetermined signal from the predetermined range is the concept including not only the process of creating the keyword enhancement mask by using the model but also the process of extracting only the signal that is estimated to be the keyword signal by using the model.

### 2. Example of Functional Configuration of the Information Providing Device

In the following, a description will be given of an example of the functional configuration of the information providing device 10 and the voice device 200 that implement the detecting process and the distribution process described above. FIG. 2 is a diagram illustrating the configuration example of the information providing device and the voice device according to the embodiment. As illustrated in FIG. 2, the voice device 200 includes a communication unit 210, an output unit 220, and an observation unit 230. Furthermore, the information providing device 10 includes a communication unit 20, a storage unit 30, and a control unit 40.

First, an example of the functional configuration of the voice device 200 will be described. The communication unit 210 is implemented by, for example, a network interface card (NIC), or the like. Then, the communication unit 210 is connected to a network N in a wired or wireless manner and sends and receives, for example, various kinds of data, input information, and association information to and from the information providing device 10.

The output unit 220 is an output device that outputs various kinds of information and is implemented by, for example, a speaker, or the like that outputs a voice signal. Furthermore, the output unit 220 may also be a display device, such as a monitor that outputs characters or image.

The observation unit 230 is an observation device that observes the signal targeted for various kinds of observation. For example, the observation unit 230 is implemented by the plurality of microphones #1 and #2 that are placed at different positions. For example, the observation unit 230 outputs the observation signal observed by each of the microphones at the same time to the information providing device 10.

Furthermore, other than the functional configuration illustrated in FIG. 2, the voice device 200 may also include a processing unit that performs a process on various kinds of information and a storage unit. The processing unit may also be implemented by, for example, an integrated circuit, such as a central processing unit (CPU), a micro processing unit (MPU), an application specific integrated circuit (ASIC), or a field programmable gate array (FPGA). Furthermore, the storage unit may also be implemented by a semiconductor memory device, such as a Random Access Memory (RAM) or a flash memory, or implemented by a storage device, such as a hard disk or an optical disk.

In the following, an example of the functional configuration of the information providing device 10 will be described. For example, the communication unit 20 is implemented by, for example, an NIC or the like. Then, the communication unit 20 is connected to the network N in a wired or wireless manner and sends and receives, for example, learning data, an observation signal, and the result of a process to and from the information processing apparatus 100 or the voice device 200.

The storage unit 30 is implemented by, for example, a semiconductor memory device, such as a RAM or a flash memory or implemented by a storage device, such as a hard disk or an optical disk. Furthermore, the storage unit 30 stores therein a learning database 31, an observation signal database 32, and a model database 33.

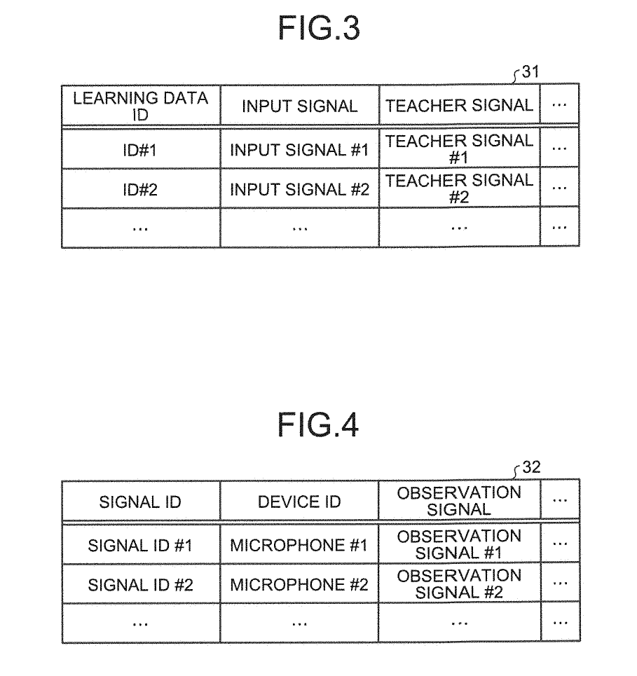

In the learning database 31, learning data is registered. For example, FIG. 3 is a diagram illustrating an example of information registered in a learning database according to the embodiment. As illustrated in FIG. 3, in the learning database 31, information having items, such as “learning data identifier (ID)”, “input signal”, “teacher signal”, and the like is registered.

Here, the “learning data ID” is an identifier for the learning data. Furthermore, the “input signal” is the signal that is used by the model at the time of learning and is, for example, a voice signal including the keyword signal. Furthermore, the “teacher signal” is the signal indicating the range in which the keyword signal is included in the associated input signal (i.e., a combination of the frequency band and the time zone in which keyword signal is included). Furthermore, the teacher signal may also be the keyword signal included in the input signal.

For example, in the example illustrated in FIG. 3, in the learning database 31, a learning data ID “ID#1”, an input signal “input signal #1”, and a teacher signal “teacher signal #1” are and by being associated with each other. This information indicates that the learning data indicated by the learning data ID “ID#1” is the input signal “input signal #1” and indicates that the keyword signal is the range that is indicated by the teacher signal “teacher signal #1” included in the input signal “input signal #1”.

Furthermore, in the example illustrated in FIG. 3, conceptual values, such as the “input signal #1” and the “teacher signal #1”, have been described; however, in practice, in the learning database 31, a voice signal or the like is to be registered as an input signal or a teacher signal. Furthermore, in addition to the information illustrated in FIG. 3, arbitrary information may also be registered in the learning database 31.

A description will be continued by referring back to FIG. 2. In the observation signal database 32, the observation signals observed by the voice device 200 are registered. For example, FIG. 4 is a diagram illustrating an example of information registered in an observation signal database according to the embodiment. As illustrated in FIG. 4, in the observation signal database 32, information having the items, such as “signal ID”, “device ID”, “observation signal”, and the like is registered.

Here, the “signal ID” is an identifier for the observation signal. Furthermore, the “device ID” is an identifier for identifying the observation device has measured the observation signal indicated by the associated signal ID, i.e., an identifier for identifying the microphones included in the voice device 200. Furthermore, the “observation signal” is the observation signal observed by the observation device indicated by the associated “device ID”.

For example, in the example illustrated in FIG. 4, in the observation signal database 32, the signal ID “signal #1”, the device ID “microphone #1”, and the observation signal “observation signal #1” are registered by being associated with each other. This information indicates that the observation signal indicated by the signal ID “signal #1” is the observation signal “observation signal #1” and is observed by the microphone indicted by the device ID “microphone #1”.

Furthermore, in the example illustrated FIG. 4, conceptual values, such as the “observation signal #1” has been described; however, in practice, in the observation signal database 32, a voice signal or the like is registered as the observation signal. Furthermore, in addition to the information illustrated in FIG. 4, in the observation signal database 32, for example, the placement position of each of the microphones may also be registered.

A description will be continued here by referring back to FIG. 2. The learned model is registered in the model database 33. For example, in the model database 33, data on the model that has an input layer in which input information that is the information input to the model is input, a plurality of intermediate layers that sequentially performs predetermined processes on the input information that was input to the input layer, and an output layer that creates output information associated with the input information based on an output of the last intermediate layer that lastly performs the process from among the plurality of intermediate layers is registered. More specifically, in the model database 33, the data indicating the connection relation between each of the nodes and the connection coefficient between the nodes is registered.

Here, the model includes a first element belonging to a layer that is one of the layers starting from the input layer to the output layer and that is other than the output layer and a second element in which a value is calculated based on the first element and the weight of the first element. By using each of the elements belonging to the layers other than the output layer as the first element and by performing, based on the first element and the weight of the first element, arithmetic calculation on the information that is input to the input layer, the model allows the computer to function such that the computer outputs, from the output layer, the information associated with the information that is input to the input layer. Furthermore, the model may also be a model that is assumed to be used as a program module that is a part of artificial intelligence software.

If an input signal corresponding to the predetermined range included in the observation signal is input to the input layer, this model allows the computer to function such that the mask that enhances the predetermined signal included in the input signal is output from the output layer. For example, the model is used in a computer that includes a CPU and a memory. Specifically, the CPU of the computer is operated so as to perform, in accordance with the command received from the learned model stored in the memory, on the input signal that is input to the input layer included in the model, arithmetic calculation based on the learned weighting factor, the response function, and the like in the neural network and then output the mask that enhances the predetermined signal (for example, keyword signal, etc.) included in the input signal that is input from the output layer.

Here, if the model is implemented by the neural network, such as the DNN, having one or a plurality of intermediate layers, the first element included in each of the models can be considered as one of the nodes included in the input layer or the intermediate layers; the second element is associated with the node in which a value is transferred from the node associated with the first element, i.e., the immediately subsequent node; and the weight of the first element is the weight considered with respect to the value that is transferred from the node associated with the first element to the node associated with the second element, i.e., the connection coefficient.

Here, the information providing device 10 creates, by using the learning data registered in the learning database 31, the model that creates the mask that enhances the predetermined signal. Namely, the learning data registered in the learning database 31 includes the input layer in which the input information is input; the output layer; the first element belonging to the layer that is one of the layers starting from the input layer to the output layer and that is other than the output layer; and the second element in which a value is calculated based on the first element and the weight of the first element and is the data that is used to allows the computer to function such that the computer outputs, by performing arithmetic calculation based on the weight in which the characteristic of the input information has been reflected, the output information (for example, the mask that enhances the keyword signal included in the input signal) associated with the input information, which has been input, is output from the output layer.

The control unit 40 is a controller and is implemented by, for example, a processor, such as a CPU, an MPU, or the like, executing various kinds of programs, which are stored in a storage device in the information providing device 10, by using a RAM or the like as a work area. Furthermore, the control unit 40 is a controller and may also be implemented by, for example, an integrated circuit, such as an ASIC or an FPGA.

Furthermore, by executing the model stored in the storage unit 30, the control unit 40 performs, on the input signal that is input to the input layer included in the model, arithmetic calculation based on the coefficients included in the model (i.e., the coefficient associated with each of the characteristics learned by the model), creates the mask that enhances the predetermined signal from the input signal that has been input, and then outputs the mask from the output layer in the model.

As illustrated in FIG. 2, the control unit 40 includes a learning unit 41, an acquiring unit 42, an estimating unit 43, a mask creating unit 44, a filter creating unit 45, an analyzing unit 46, and a providing unit 47.

The learning unit 41 learns the model. More specifically, the learning unit 41 allows the model to learn the characteristic in the range that is included in the observation signal and in which the predetermined signal is included. For example, when the observation signal that includes both the predetermined signal and the noise signal is input, the learning unit 41 learns the model such that the mask that enhances the range that is included in the observation signal and that includes the predetermined signal (for example, a combination of the time zone and the frequency) is output.

For example, the learning unit 41 creates the model having a predetermined structure and inputs the input signal #1 registered in the learning database 31 to the model. Then, regarding the input signal #1, the learning unit 41 outputs a value having a higher likelihood with respect to the range in which the signal indicated by the teacher signal #1 is included and then corrects the value of the connection coefficient included in the model by using a learning method, such as backpropagation, such that a value having a lower likelihood with respect to the other range is output. Furthermore, the learning unit 41 may also learn the model by using an arbitrary learning method. Then, the learning unit 41 registers the learned model in the model database 33.

The acquiring unit 42 acquires the observation signal that becomes the processing target. For example, the acquiring unit 42 acquires each of the observation signals acquired by the voice device 200 by using each of the microphones. In such a case, the acquiring unit 42 registers the observation signal in the observation signal database 32.

The estimating unit 43 estimates the predetermined range that is included in the observation signal and in which the predetermined signal is included. For example, the estimating unit 43 estimates the range in which the predetermined signal is included in the voice signal as the predetermined range. For example, the estimating unit 43 reads out each of the observation signals registered in the observation signal database 32 and estimates, for each read out observation signal, as the predetermined signal, the range in which the signal with the waveform or the frequency characteristic having a predetermined characteristic. For example, the estimating unit 43 estimates, in the voice signal observed as the observation signal, the voice signal obtained when the user U spoke a predetermined keyword, i.e., the range in which the keyword signal is included, as the predetermined range. More specifically, the estimating unit 43 estimates the predetermined range in which the predetermined signal is included in each of the plurality of observation signals simultaneously acquired by the plurality of acquisition devices each of which is placed at a different position.

For example, by using an arbitrary voice estimation technology, the estimating unit 43 estimates, as the predetermined range, the range that is in the observation signal and in which the keyword signal is highly likely to be included. Furthermore, for example, by using the learning model that was learned by the learning unit 41, the estimating unit 43 may also specify the area in which the keyword signal is highly likely to be included from among the areas of the observation signal and estimate the time zone that includes the specified area as the predetermined range.

By using the model that learns the characteristic held by the predetermined signal, the mask creating unit 44 creates the mask that enhances the similar signal having the characteristic similar to that of the predetermined signal from among the signals included in the predetermined range. For example, by using the model obtained by performing deep learning on the waveform or the frequency characteristic in the range that is in the observation signal and in which the predetermined signal is included, the mask creating unit 44 creates the mask that enhances the similar signal having the characteristic that is similar to that of the predetermined signal in the signal included in the predetermined range.

For example, the mask creating unit 44 extracts the predetermined range that has been estimated by the estimating unit 43 and that is include in the observation signal and inputs, as the input signal, the signal included in the extracted predetermined range to the learned model. Then, the mask creating unit 44 acquires the output of the learned model as the mask that enhances the keyword signal. Namely, regarding the signal included in the observation signal, the mask creating unit 44 creates the mask that enhances the signal that is estimated to be the keyword signal (i.e., the signal having the characteristic similar to that of the keyword signal whose characteristic has been learned).

Then, by using the created mask, the mask creating unit 44 creates the enhancement signal in which the keyword signal included in the predetermined range has been enhanced. For example, the mask creating unit 44 creates the enhancement signal in which the learned model amplifies the amplitude of the signal included in each of the areas of the predetermined range in accordance with the likelihood calculated for each area of the predetermined range.

The filter creating unit 45 creates, based on the enhancement range in which the predetermined signal that is included in the signal included in the predetermined range has been enhanced, the filter that is used to enhance the signal having the same characteristic as that of the predetermined signal from the range other than the predetermined range included in the observation signal. Namely, by using the keyword signal included in the observation signal, the filter creating unit 45 creates the filter that is used to enhance the signal having the same characteristic as that of the keyword signal, i.e., the target signal.

For example, based on the signal that is included in the voice signal and that is included in the predetermined range, the filter creating unit 45 creates the filter that is used to enhance the signal having the same characteristic as that of the predetermined signal from the range other than the predetermined range included in the voice signal. Specifically, the filter creating unit 45 acquires the enhancement signal created by the mask creating unit 44 from the observation signal that has been acquired for each microphone. In such a case, the filter creating unit 45 extracts the signal that is highly likely to be the keyword signal in the signals included in the corresponding enhancement signals. Then, the filter creating unit 45 creates the filter that is used to enhance the signal having the same characteristic as that of the predetermined signal from the range that is subsequent to the predetermined range from the signal extracted from each of the enhancement signals. Namely, the filter creating unit 45 creates the filter based on the predetermined range in which the similar signal has been enhanced.

For example, based on the time at which the signal extracted from each of the enhancement signals was observed and based on the placement position of each of the microphones, the filter creating unit 45 estimates the arrival direction of the extracted signal, i.e., the keyword signal. Then, the filter creating unit 45 creates the filter that is used to enhance the signal arriving from the estimated arrival direction. Namely, the filter creating unit 45 creates the filter that is used to enhance the signal having the spatial characteristic similar to that of the predetermined signal from the range other than the predetermined range included in each of the plurality of the observation signals. For example, the filter creating unit 45 creates, as the filter, the weighting factor used when the observation signals acquired by the individual microphones are combined.

Furthermore, the filter creating unit 45 may also create a function that is used to enhance the signal having the frequency characteristic similar to that of the predetermined signal from the range other than the predetermined range included in each of the plurality of the observation signals. For example, because a keyword and an indication speech are spoken by the same user U, it is conceivable that the keyword and the indication speech have similar frequency characteristics. Thus, the filter creating unit 45 may also estimate the frequency characteristic of the enhanced keyword signal and create the filter that is used to enhance the signal having the frequency characteristic estimated from the observation signal.

By using the filter created by the filter creating unit 45, the analyzing unit 46 extracts the target signal from the range other than the predetermined range included in the observation signal. Then, the analyzing unit 46 analyzes the extracted target signal and specifies the indication speech of the user U. For example, the analyzing unit 46 combines, by using the filter created by the filter creating unit 45, the observation signals acquired by the individual microphones. For example, the analyzing unit 46 extracts, as the indication range, the range subsequent to the predetermined range from each of the observation signals. Then, the analyzing unit 46 creates the combination indication range obtained by combining indication ranges by considering the weighting factor created by the filter creating unit 45 as the filter. Then, the analyzing unit 46 analyzes the signals included in the combination indication range and specifies the indication speech spoken by the user U.

The providing unit 47 performs the process in accordance with the indication speech of the user U and provides the result of the process to the voice device 200. For example, if the content of the indication speech is “what is the weather today?”, the providing unit 47 acquires a weather forecast from an external server and creates voice data that reads out the content of the acquired weather forecast. Then, by providing the created voice data to the voice device 200 and allowing the voice device 200 to play back the voice data, the providing unit 47 provides the result of the process associated with the indication speech of the user U.

### 3. Example of Accuracy

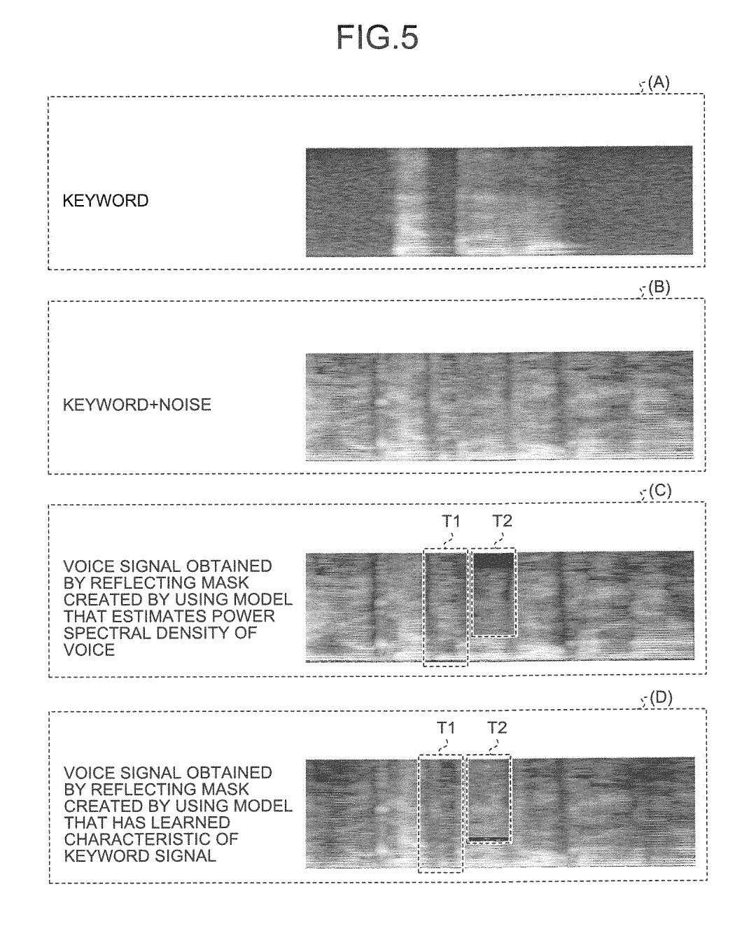

In the following, a description will be given of an example of the result of the process of enhancing the keyword signal from the predetermined range performed by using the model described above. FIG. 5 is a diagram illustrating an example of results of processes in each of which the information providing device according to the embodiment enhances a signal. Furthermore, the example illustrated in FIG. 5 illustrates an example of the power spectrum of each of a first voice signal that includes only the spoken voice of a keyword, a second voice signal that includes both the spoken voice of the keyword and noise, a third voice signal in which the mask created by using the model that estimates the power spectral density of the second voice signal regarding the voice has been reflected, and a fourth voice signal in which the mask created by using the model that has learned the characteristic of the keyword signal regarding the second voice signal has been reflected.

For example, the part indicated by (A) illustrated in FIG. 5 indicates the power spectrum of the first voice signal that includes only the spoken voice of the keyword and the part indicated by (B) illustrated in FIG. 5 indicates the power spectrum of the second voice signal that includes both the spoken voice of the keyword and the noise. As indicated by (B) illustrated in FIG. 5, in the second voice signal that includes both the keyword and the noise, the keyword signal corresponding to the spoken voice of the keyword is hidden by the noise.

Furthermore, the part indicated by (C) illustrated in FIG. 5 indicates the power spectrum of the third voice signal in which the mask created by using the model that estimates the power spectral density of the second voice signal regarding the voice has been reflected. As indicated by (C) illustrated in FIG. 5, in the third voice signal, the voice included in timing T1, i.e., the noise signal that is not the keyword signal, has not been removed and the voice included in timing T2, i.e., the keyword signal, has been removed together with the noise.

In contrast, the part indicated by (D) illustrated in FIG. 5 indicates the power spectrum of the fourth voice signal in which the mask created by using the model that has learned the characteristic of the keyword signal regarding the second voice signal, i.e., the learned model that has performed the learning based on the learning process described above, has been reflected. As indicated by (D) illustrated in FIG. 5, in the fourth voice signal, the voice included in the timing T1, i.e., the noise signal that is not the keyword signal, is more reduced when compared with the third voice signal and the voice included in the timing T2, i.e., the keyword signal, still remains with greater amount when compared with the third voice signal.

If the signal that is estimated to be the keyword signal is extracted by using the fourth voice signal described above, it is possible to extract the signal having the component of the keyword signal greater that is greater than that of the noise. If the filter that enhances the target signal of the indication speech or the like is created by using the signal described above, it is possible to create the filter that enhances the target signal more accurately. Consequently, the information providing device 10 can improve the recognition accuracy of the target signal.

### 4. Flow of the Process Performed by the Information Providing Device

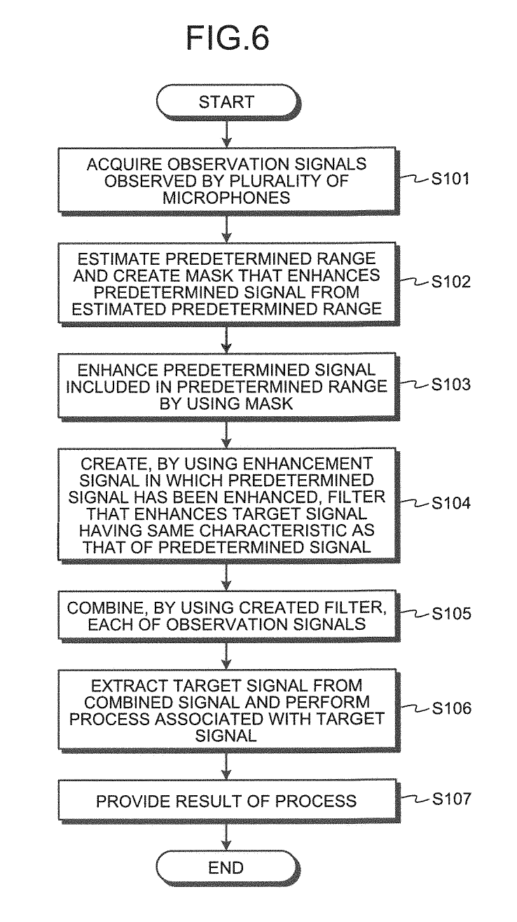

In the following, an example of the flow of the process performed by the information providing device 10 will be described with reference to FIG. 6. FIG. 6 is a flowchart illustrating an example of the flow of the process performed by the information providing device according to the embodiment.

First, the information providing device 10 acquires the observation signals observed by the plurality of microphones (Step S101). In such a case, the information providing device 10 estimates the predetermined range in which the predetermined signal, such as the keyword signal, is included and creates the mask that enhances the predetermined signal from the estimated predetermined range (Step S102). Then, the information providing device 10 enhances the predetermined signal included in the predetermined range by using the mask (Step S103).

Furthermore, by using the enhancement signal in which the predetermined signal has been enhanced, the information providing device 10 creates the filter that enhances the target signal having the same characteristic as that of the predetermined signal (Step S104). Then, the information providing device 10 combines, by using the created filter, each of the observation signals (Step S105). Namely, by combining each of the observation signals by using the cratered filter, the information providing device 10 creates the signal in which the target signal included in each of the observation signals has been enhanced.

Furthermore, the information providing device 10 extracts the target signal from the combined signal and performs the process associated with the target signal (Step S106). Then, the information providing device 10 provides the result of the process (Step S107) and ends the process.

### 5. Modification

In the embodiment described above, an example of the learning process and the creating process performed by the information providing device 10 has been described. However, the embodiment is not limited to this. In the following, the variation in the detecting process and the distribution process performed by the information providing device 10 will be described.

### 5-1. Device Configuration

Each of the databases 31 to 33 registered in the storage unit 30 may also be held by an external storage server. Furthermore, the information providing device 10 may also be implemented by operating, in cooperation with each other, a learning server that performs the learning process, a creating server that performs the creating process, and a processing server that performs various processes in accordance with the speeches of the user U. In such a case, the learning unit 41 may be arranged in the learning server; the acquiring unit 42, the estimating unit 43, the mask creating unit 44, and the filter creating unit 45 may be arranged in the creating server; and the analyzing unit 46 and the providing unit 47 may be arranged in the processing server.

Furthermore, for example, the estimating unit 43, the mask creating unit 44, and the filter creating unit 45 may be included in the voice device 200. Namely, the creating process may also be implemented by the voice device 200.

### 5-2. Others

Of the processes described in the embodiment, the whole or a part of the processes that are mentioned as being automatically performed can also be manually performed, whereas the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the embodiments described above can be appropriately used in combination as long as the processes do not conflict with each other.

### 5-3. Programs

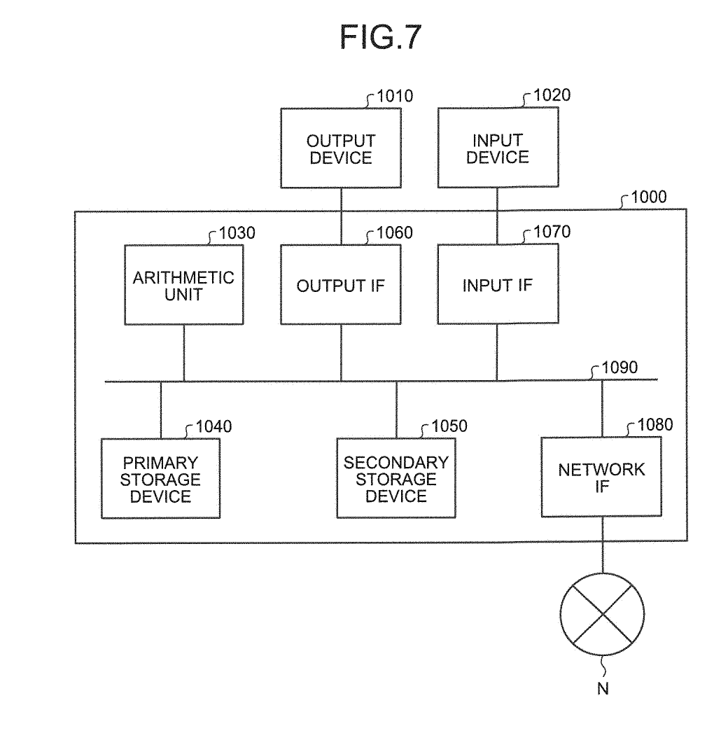

Furthermore, the information providing device 10 according to the embodiment described above is implemented by a computer 1000 having the configuration illustrated in, for example, FIG. 7. FIG. 7 is a diagram illustrating an example of hardware configuration. The computer 1000 has the configuration in which the computer 1000 is connected to an output device 1010 and an input device 1020 and includes an arithmetic unit 1030, a primary storage device 1040, a secondary storage device 1050, an output interface (IF) 1060, an input IF 1070, a network IF 1080 that are connected by a bus 1090.

The arithmetic unit 1030 is operated based on the programs stored in the primary storage device 1040 or the secondary storage device 1050 or based on the programs read from the input device 1020 and performs various kinds of processes. The primary storage device 1040 is a memory device, such as a RAM, that primarily stores therein data that is used by the arithmetic unit 1030 to perform various kinds of arithmetic operations. Furthermore, the secondary storage device 1050 is a storage device in which data that is used by the arithmetic unit 1030 to perform various kinds of arithmetic operations and various kinds of databases are registered and is implemented by a read only memory (ROM), an HDD, a flash memory, and the like.

The output IF 1060 is an interface for sending information that is targeted for an output with respect to the output device 1010, such as a monitor, a printer, or the like, that outputs various kinds of information and is implemented by, for example, the standard connector, such as a universal serial bus (USB), a digital visual interface (DVI), a High Definition Multimedia Interface (registered trademark) (HDMI), or the like. Furthermore, the input IF 1070 is an interface for receiving information from various kinds of the input device 1020, such as a mouse, a keyboard, a scanner, or the like, and is implemented by, for example, an USB, or the like.

Furthermore, the input device 1020 may also be, for example, an optical recording medium, such as a compact disc (CD), a digital versatile disc (DVD), a phase change rewritable disk (PD), or the like; a magneto-optical recording medium, such as a magneto-optical disk (MO), or the like; or a device that reads information from a tape medium, a magnetic recording medium, a semiconductor memory, or the like. Furthermore, the input device 1020 may also be an external storage medium, such as a USB memory, or the like.

The network IF 1080 receives data from another device via the network N and sends the data to the arithmetic unit 1030. Furthermore, the network IF 1080 sends the data created by the arithmetic unit 1030 to the other device via the network N.

The arithmetic unit 1030 controls the output device 1010 and an input device 1020 via the output IF 1060 and the input IF 1070, respectively. For example, the arithmetic unit 1030 loads the program from the input device 1020 or the secondary storage device 1050 into the primary storage device 1040 and executes the loaded program.

For example, if the computer 1000 functions as the information providing device 10, the arithmetic unit 1030 in the computer 1000 implements the function of the control unit 40 by executing the program of data (for example, the model Ml) loaded in the primary storage device 1040. The arithmetic unit 1030 in the computer 1000 reads the program or the data (for example, the model Ml) from the primary storage device 1040 and executes the program or the data; however, as another example, the program may also be acquired from other devices via the network N.

### 6. Effects

As described above, the information providing device 10 estimates a predetermined range that is included in the observation signal and in which a predetermined signal is included. Then, based on an enhancement range in which the predetermined signal included in the signals included in the predetermined range has been enhanced, the information providing device 10 creates a filter that is used to enhance a signal having the same characteristic as that of the predetermined signal from the range other than predetermined range that is included in the observation signal. Consequently, the information providing device 10 can create the filter that can accurately enhance the signal having the same characteristic as that of the predetermined signal, i.e., the target signal, thereby improving the recognition accuracy of the target signal.

Furthermore, the information providing device 10 estimates a range in which, as the predetermined signal, a signal that has the waveform or the frequency characteristic having a predetermined characteristic is included. For example, as the predetermined signal, the information providing device 10 estimates the range in which a voice signal obtained when the user U spoke a predetermined keyword is included. Furthermore, the information providing device 10 creates the filter that is used to enhance the signal having the same characteristic as that of the predetermined signal from a range subsequent to the predetermined range included in the observation signal. Consequently, the information providing device 10 can improve the recognition accuracy of an indication speech spoken by the user U subsequent to, for example, the keyword.

Furthermore, from among a plurality of observation signals simultaneously acquired by a plurality of acquisition devices each of which is placed at a different position, the information providing device 10 estimates the predetermined range in which the predetermined signal is included. Then, the information providing device 10 creates a filter that is used to enhance a signal having a spatial characteristic similar to that of the predetermined signal from a range other than the predetermined range that is included in each of the plurality of observation signals. For example, the information providing device 10 creates, as the filter, the weighting factor used when combining each of the observation signals acquired by the plurality of acquisition devices. Furthermore, the information providing device 10 creates the filter based on the signal that is included in the predetermined range included in the observation signal. Consequently, the information providing device 10 creates the filter that can accurately enhance the signal arriving from the same direction as that of the predetermined signal that is previous to, for example, the target signal, thereby improving the recognition accuracy of the target signal.

Furthermore, the information providing device 10 creates a function that is used to enhance a signal having the frequency characteristic similar to that of the predetermined signal from the range other than the predetermined range that is included in the plurality of observation signals. Consequently, the information providing device 10 can create the filter that can accurately enhance the signal generated from the same source as that of, for example, the target signal.

Furthermore, by using a mask that enhances a signal having a characteristic similar to that of the predetermined signal, the information providing device 10 creates an enhancement range in which the predetermined signal has been enhanced from among each of the signals included in the predetermined range and creates the filter based on each of the signals included in the created enhancement range, i.e., the enhancement signal. For example, by using a model that has learned the characteristic held by the predetermined signal, the information providing device 10 creates the mask that enhances the characteristic similar to that of the predetermined signal from among the signals included in the predetermined range and creates the enhancement range by using the created mask. Furthermore, the information providing device 10 uses, as the model, the model obtained by performing deep learning on the waveform or the frequency characteristic in the range in which the predetermined signal included in the observation signal is included. Consequently, because the information providing device 10 can accurately enhance the signal in which the predetermined signal is estimated from the predetermined range, the information providing device 10 implements creating the filter that accurately enhances the signal similar to that of the predetermined signal, thereby improving the recognition accuracy of the target signal.

Furthermore, the information providing device 10 estimates, as the predetermined range, a range in which the predetermined signal is included in the voice signal and creates, based on the signal included in the enhancement range in which the predetermined signal that is included in the signal included in the predetermined range has been enhanced, the filter that is used to enhance the signal having the same characteristic as that of the predetermined signal included in the voice signal from the range other than the predetermined range. Consequently, the information providing device 10 can create the filter that can accurately enhance a speech of the predetermined user U, such as the user who spoke, for example, a keyword, thereby improving the recognition accuracy of the target signal of an indication speech or the like.

In the above, embodiments of the present invention have been described in detail based on the drawings; however the embodiments are described only by way of an example. In addition to the embodiments described in disclosure of invention, the present invention can be implemented in a mode in which various modifications and changes are made in accordance with the knowledge of those skilled in the art.

Furthermore, the “components (sections, modules, units)” described above can be read as “means”, “circuits”, or the like. For example, the detecting unit can be read as a detecting means or a detecting circuit.

According to an aspect of an embodiment, it is possible to improve the recognition accuracy of a target signal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A creating device comprising:
an estimating unit that estimates a predetermined range that is included in an observation signal and in which a predetermined signal is included; and
a creating unit that creates, based on an enhancement range in which the predetermined signal included in a signal included in the predetermined range has been enhanced, a filter that is used to enhance a signal having the same characteristic as that of the predetermined signal from a range other than the predetermined range that is included in the observation signal.

2. The creating device according to claim 1, wherein the estimating unit estimates a range in which, as the predetermined signal, a signal that has a waveform or a frequency characteristic having a predetermined characteristic is included.

3. The creating device according to claim 2, wherein the estimating unit estimates a range in which, as the predetermined signal, a voice signal obtained when a user spoke a predetermined keyword is included.

4. The creating device according to claim 1, wherein the creating unit creates the filter that is used to enhance the signal having the same characteristic as that of the predetermined signal from a range that is subsequent to the predetermined range included in the observation signal.

5. The creating device according to claim 1, wherein
the estimating unit estimates, from among a plurality of observation signals simultaneously acquired by a plurality of acquisition devices each of which is placed at a different position, the predetermined range in which the predetermined signal is included, and
the creating unit creates a filter that is used to enhance a signal having a spatial characteristic similar to that of the predetermined signal from a range other than the predetermined range that is included in each of the plurality of the observation signals.

6. The creating device according to claim 5, wherein the creating unit creates, as the filter, a weighting factor used when combining each of the observation signals acquired by the plurality of acquisition devices.

7. The creating device according to claim 1, wherein the creating unit creates a function that is used to enhance a signal having the frequency characteristic similar to that of the predetermined signal from the range other than the predetermined range that is included in the observation signal.

8. The creating device according to claim 1, wherein the creating unit creates, by using a mask that enhances a signal having a characteristic similar to that of the predetermined signal, an enhancement range in which the predetermined signal has been enhanced from among each of the signals included in the predetermined ranges and creates the filter based on each of the signals included in the enhancement ranges.

9. The creating device according to claim 8, wherein the creating unit creates, by using a model that has learned the characteristic held by the predetermined signal, the mask that enhances the characteristic similar to that of the predetermined signal from among the signals included in the predetermined range and creates the enhancement range by using the created mask.

10. The creating device according to claim 9, wherein the creating unit uses, as the model, a model obtained by performing deep learning on the waveform or the frequency characteristic in the range that is in the observation signal and in which the predetermined signal is included.

11. The creating device according to claim 1, wherein
the estimating unit estimates, as the predetermined range, a range in which the predetermined signal is included in the voice signal, and
the creating unit creates, based on the signal included in the enhancement range, the filter that is used to enhance the signal having the same characteristic as that of the predetermined signal included in the voice signal from the range other than the predetermined range.

12. A creating method performed by a creating device comprising:
estimating a predetermined range that is included in an observation signal and in which a predetermined signal; and
creating, based on an enhancement range in which the predetermined signal included in a signal included in the predetermined range has been enhanced, a filter that is used to enhance a signal having the same characteristic as that of the predetermined signal from a range other than the predetermined range that is included in the observation signal.

13. A non-transitory computer-readable storage medium having stored therein a creating program that causes a computer to execute a process comprising:
estimating a predetermined range that is included in an observation signal and in which a predetermined signal; and
creating, based on an enhancement range in which the predetermined signal included in a signal included in the predetermined range has been enhanced, a filter that is used to enhance a signal having the same characteristic as that of the predetermined signal from a range other than the predetermined range that is included in the observation signal.
